(19) United States
(12) Patent Application Publication
(10) Pub. No.: US 2013/0166372 A1
(43) Pub. Date: Jun. 27, 2013

(54) UTILIZING REAL-TIME METRICS TO NORMALIZE AN ADVERTISEMENT BASED ON CONSUMER REACTION

(71) Applicants: SUBIL M. ABRAHAM, (US); TAM M. CAO, TROPHY CLUB, TX (US); JASON A. GONZALEZ, LEWISVILLE, TX (US); MATHEWS THOMAS, FLOWER MOUND, TX (US)

(72) Inventors: SUBIL M. ABRAHAM, (US); TAM M. CAO, TROPHY CLUB, TX (US); JASON A. GONZALEZ, LEWISVILLE, TX (US); MATHEWS THOMAS, FLOWER MOUND, TX (US)

(73) Assignee: INTERNATIONAL BUSINESS MACHINES CORPORATION, ARMONK, NY (US)

(21) Appl. No.: 13/336,293

(22) Filed: Dec. 23, 2011

(51) Int. Cl. G06Q 30/02

(52) U.S. Cl. 705/14.42; 705/14.44

(57) ABSTRACT

One or more consumers proximate to a kiosk can be detected. The kiosk can present a product advertisement associated with a product. The product can be a good or a service. Metrics associated with the consumers can be collected responsive to interacting with the product advertisement. The interaction can be a visual and aural interaction. The metrics can be analyzed to determine an impression associated with the consumers interacting with the product advertisement. The impression can be a rational descriptor and/or an emotional descriptor. The rational descriptor and/or emotional descriptor can be a computer readable value associated with a behavioral change of the consumers responsive to the interacting. A normalized content can be generated based on the impression associated with the consumer. The normalized content can adjust the product advertisement to improve the impression.

### BACKGROUND

The present invention relates to the field of product advertisement and, more particularly, to utilizing real-time metrics to normalize an advertisement based on consumer reaction.

In recent years consumer behavior has evolved and their tastes/interests in products change rapidly. As a result, retailers frequently are forced to develop a steady stream of new products to cater to growing needs. However, new products continue to fail at a staggering rate. For example, a significant portion of new products fail within two years after being introduced. In addition, a large amount of marketing effort and money is spent annually by corporations for product launches. That is, it is becoming increasingly important for corporations to be successful in introducing new products.

The most common way for evaluating and measuring consumer interest in a new product is to conduct surveys, interviews, and gather social data to obtain emotional and rational descriptors. Another common approach is analyzing point-of-sales and online transactions to obtain a descriptive indication of how the consumers react to a new product. However, these traditional solutions involve considerable time and a substantial investment to obtain information useful in determining a product success. That is, manufacturers and/or retailers still face significant risks when launching new products despite traditional solutions.

### BRIEF SUMMARY

One aspect of the present invention can include a system, an apparatus, a computer program product, and a method for utilizing real-time metrics to normalize an advertisement based on consumer reaction. One or more consumers proximate to a kiosk can be detected. The kiosk can present a product advertisement associated with a product. The product can be a good or a service. Metrics associated with the consumers can be collected responsive to interacting with the product advertisement. The interaction can be a visual and aural interaction. The metrics can be analyzed to determine an impression associated with the consumers interacting with the product advertisement. The impression can be a rational descriptor and/or an emotional descriptor. The rational descriptor and/or emotional descriptor can be a computer readable value associated with a behavioral change. The behavioral change can relate to a user response or interaction with a graphical user interface showing the product advertisement. A normalized content can be generated based on the impression associated with the consumer. The normalized content can adjust the product advertisement to improve the impression.

Another aspect of the present invention can include an apparatus, a computer program product, a method, and a system for utilizing real-time metrics to normalize an advertisement based on consumer reaction. An impression engine can be configured to establish a group impression of a product advertisement. The advertisement can be associated with a kiosk. The advertisement can be associated with product information. The product information can be associated with a product. The product can be a good or a service. A data store can be configured to store the group impression and a normalization content.

Yet another aspect of the present invention can include a computer program product, a method, a system, and an apparatus for utilizing real-time metrics to normalize an advertisement based on consumer reaction. A product kiosk can include sensors able to collect metrics in real-time associated with consumers proximate to the kiosk. The kiosk can be configured to automatically determine an impression of the consumers. The impression can be associated with a product advertisement. The product advertisement can be comprised of product information.

### BRIEF DESCRIPTION OF THE SEVERAL VIEWS OF THE DRAWINGS

FIG. 1 is a schematic diagram illustrating a scenario for utilizing real-time metrics to normalize an advertisement based on consumer reaction in accordance with an embodiment of the inventive arrangements disclosed herein.

FIG. 2 is a schematic diagram illustrating a method for utilizing real-time metrics to normalize an advertisement based on consumer reaction in accordance with an embodiment of the inventive arrangements disclosed herein.

FIG. 3 is a schematic diagram illustrating a system for utilizing real-time metrics to normalize an advertisement based on consumer reaction in accordance with an embodiment of the inventive arrangements disclosed herein.

FIG. 4 is a schematic diagram illustrating an embodiment for utilizing real-time metrics to normalize an advertisement based on consumer reaction in accordance with an embodiment of the inventive arrangements disclosed herein.

### DETAILED DESCRIPTION

The present disclosure is a solution for utilizing real-time metrics to normalize an advertisement based on consumer reaction. In the solution, a kiosk can present a product advertisement associated with a product (e.g., product/service). Sensors (e.g., video camera) can be utilized to collect metrics from proximate consumers (e.g., passerby). Metrics can include, but are not limited to, non-verbal communication (e.g., facial expressions, body language), verbal communication, proxemics, and the like. Metrics can be analyzed to determine an impression of the consumer in response to the advertisement. When multiple consumers are determined to be part of a group, the disclosure can evaluate the consumer impressions to determine a total group impression. The group impression can be evaluated to establish whether the advertisement is favorable or unfavorable to the group. In one instance, when the advertisement is unfavorable, the advertisement can be normalized to improve the group impression. That is, the advertisement can be automatically modified to change the group impression from unfavorable to favorable.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store, a program for use by or in connection with an instruction processing system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction processing system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

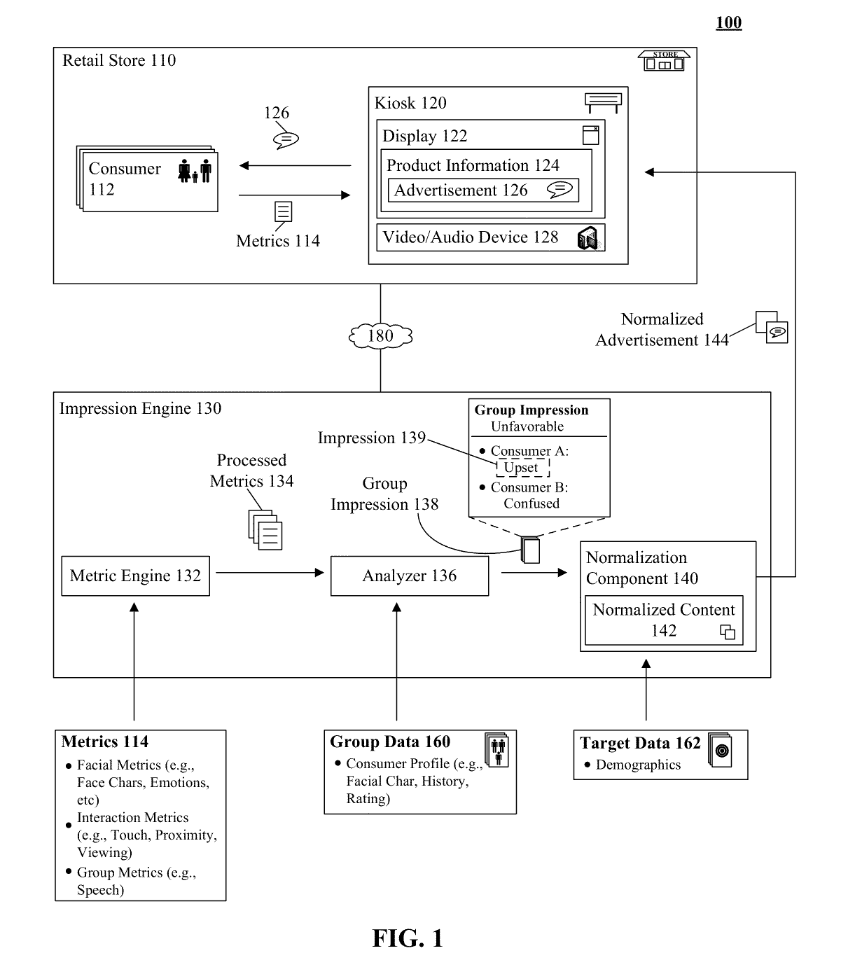

FIG. 1 is a schematic diagram illustrating a scenario 100 for utilizing real-time metrics to determine consumer interest in accordance with an embodiment of the inventive arrangements disclosed herein. Scenario 100 can be performed in the context of method 200, system 300, and/or embodiment 400, 420. In scenario 100, a kiosk 120 residing within a retail store 110 can present product advertisement 126 to a proximate consumer 112. Product advertisement 126 can be associated with a product (e.g., good/service). Consumer 112 can interact with advertisement (e.g., view advertisement) and consumer 112 reaction (e.g., behavior) can be observed via video/audio device 128 within kiosk 120. Metrics 114 can be collected of consumer 112 reaction. Metrics 114 can be conveyed to impression engine 130 which can be communicatively linked to store 110 (e.g., via network 180). Engine 130 can process metrics to determine consumer 112 impression 139 to advertisement 126. In one instance, when impression 138 is unfavorable, normalized content 142 can be generated and conveyed to kiosk 120. Kiosk 120 can utilize content 142 to appropriately normalize advertisement 126 to improve consumer reaction to advertisement 126. That is, the disclosure can permit dynamic real-time targeted advertisement (e.g., normalized advertisement 144) based on consumer 112 impression.

As used herein, a product (e.g., product 342) can be a good and/or service produced within an economy. Product can be associated with advertisement 126 which can present product information 124. Product information 124 can be a data set associated with a product and/or an advertisement 126. Product information can be associated with one or more marketing strategies. Marketing strategy can include an organizational function and/or a set of processes for creating, communicating, and delivering value to consumers. The marketing strategy can be utilized to manage consumer relationships in ways that benefit the organization and organizational stakeholders. Marketing strategy can be associated with one or more products which can be presented within advertisement 126. For example, advertisement 126 can be a series of advertisements presenting a new line of cold beverages.

As used herein, retail store 110 can be a location providing one or more goods and/or services. Retail store 110 can be a department store, boutique, a mall, and the like. It should be appreciated that retail store 110 can be presented for exemplary purposes only and should not be construed to limit the invention in any regard. Retail store 110 can include locations such as parks (e.g., hosting outdoor events), buildings (e.g., office buildings), and/or any location which can house kiosk 120.

As used herein, consumer 112 can be a human individual who uses goods and/or services generated within an economy. Consumer 112 can interact with kiosk 120 in one or more ways including, but not limited to, sight, sound, touch, and the like. For example, kiosk 120 can present an interactive commercial advertising a beauty product. The consumer 112 can include a group of individuals such as a family. For example, consumer 112 can be a family of shoppers within a clothing store.

Kiosk 120 can be a physical and/or electronic entity able to present advertisement 126. Kiosk 120 can include, but is not limited to, a mechanical signage, an electronic signage, a billboard, and the like. Kiosk 120 can include multiple kiosks at two or more locations. Kiosk 120 can include, but is not limited to, display 122, product information 124, advertisement 126, video/audio device 128, and the like. Display 122 can present product information 124, advertisement 126, and the like. Display 122 can include two-dimensional displays, three-dimensional displays, and the like. Display 122 can include touch sensitive portions (e.g., touch screen) permitting tactile interaction with a consumer 112. For example, kiosk 120 can display advertisement for products within retail store to entice consumers 112 to purchase a sale item by presenting an interactive commercial.

Video/audio device 128 can be utilized to collect metrics 114 from proximate consumer 112. In one instance, device 128 can collect biometrics which can be utilized to tailor advertisement 126 using normalization content 142. In the instance, facial recognition technology can be used to identify relevant demographic information (e.g., age) of consumer 112 which can permit advertisement 126 to be tailored to consumer 112. For example, video/audio device 128 can be a video camera able to detect facial expressions of proximate consumers 112.

Metrics 114 can be one or more measurements associated with consumer 112. Metrics 114 can include, but is not limited to, facial metrics (e.g., biometrics), interaction metrics (e.g. proxemics), group metrics, and the like. Metrics 114 can be collected in real-time or near real-time permitting dynamic normalization of advertisement 126 based on consumer 112 reaction. It should be appreciated that metrics 114 can be collected from one or more consumers 112.

Metrics can be received by metric engine 132 which can process metrics to produce processed metrics 134. In one instance 132 can be utilized to remove non-relevant metrics and/or consumer sources. For example, object recognition can be utilized to remove entities incorrectly identified as consumers such as a toy doll. Processed metrics 134 can be conveyed to analyzer 136 which can utilize group data 160 to generate an impression based on consumer 112 reaction.

Analyzer 136 can employ facial metrics to positively identify a consumer 112. For example, facial features can be used to determine if the consumer is upset at viewing the advertisement 126. In one instance, consumer 112 can be linked to personally identifiable information. In another instance, consumer 112 can be identified utilizing previous interactions with the kiosk and not linked to personally identifiable information. Analyzer 136 can utilize consumer 112 facial metrics to determine an impression 139. Impression 139 can be a consumer 112 emotional and/or rational reaction based on interaction with advertisement 126. Impression 139 can include, but is not limited to, an emotional descriptor, a rational descriptor, and the like. Descriptors can be associated with a favorable impression, unfavorable impression, and the like. In one instance, descriptors can be associated with a range of impressions.

In one instance, a group impression 138 can be generated when consumer 112 includes multiple consumers 112. The group impression 138 can be evaluated to determine advertisement 126 impact on the consumers 112. For example, a group impression of unfavorable can be determined when Consumer A is upset upon viewing the advertisement and Consumer B is confused by the advertisement.

Based on the impression 139, normalization component 140 can be utilized to adjust the advertisement 126. Utilizing target data 162, component 140 can produce normalized content 142. Content 142 can be employed to create normalized advertisement 144 which can be conveyed to kiosk 120. Target data 162 can include, but is not limited to, demographics, trending information (e.g., popular trends), and the like. Normalized content 142 can include, but is not limited to, video content, audio content, text content, and the like. In one instance, advertisement 144 can be a replacement advertisement which can be presented instead of advertisement 126. For example, a different advertisement associated with the same marketing strategy for the product can be utilized. In another instance, content 142 can be conveyed to kiosk 120 and can be additional content which can be presented in tandem with advertisement 126. For example, content 142 can include product information (e.g., information 124) which can be presented to interest a consumer 112.

In one instance, consumer 112 can be associated with a weighting mechanic permitting complex evaluation of consumer 112 reaction. In one embodiment, consumer 112 shopping history can be utilized to determine consumer 112 relevance. For example, if the consumer 112 frequently purchases the product being advertised, the consumer 112 can be deemed significantly relevant. In one embodiment, a rating system can be associated with the consumer 112 to determine consumer 112 importance. In the embodiment, the rating system can include a computed value using one or more inputs (e.g., shopping history, age, income) to determine a rating.

Drawings presented herein are for illustrative purposes only and should not be construed to limit the invention in any regard. It should be appreciated that kiosk 120 is not limited to the configuration presented herein. Other configurations for kiosk 120 can be contemplated. The disclosure can leverage multiple kiosks at multiple locations to correlate consumer 112 impression of advertisement 126. For example, when the consumer views the advertisement three times at three different locations, the content can be normalized based on an aggregate impression determined and presented when the consumer 112 is subsequently proximate to a kiosk.

It should be appreciated that the disclosure can leverage social crowds to gain insight into a group's response to a product or a strategy. For example, digital media devices (e.g., kiosk) can be fitted with a camera and a microphone to observe the reactions and expressions from the social crowd which can help a retailer assess the consumer interest in that product.

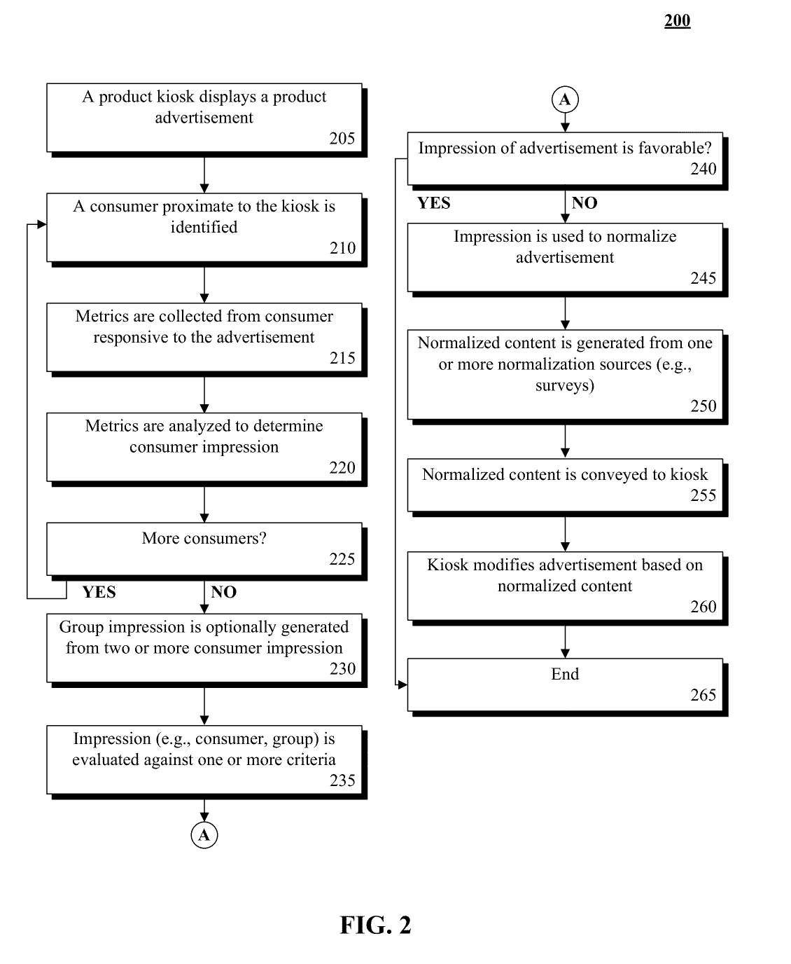

FIG. 2 is a schematic diagram illustrating a method 200 for utilizing real-time metrics to normalize an advertisement based on consumer reaction in accordance with an embodiment of the inventive arrangements disclosed herein. Method 200 can be performed in the context of scenario 100, system 300, and/or embodiment 400, 420. In method 200, a product kiosk can present a product advertisement associated with a product. A proximate consumer interacting with the kiosk can be detected. Metrics associated with the consumer can be collected by the kiosk. The metrics can be analyzed to determine the consumer impression. The consumer impression can be evaluated to determine when advertisement can be normalized to improve and/or enhance consumer impression. When the advertisement can be normalized, normalized content can be generated and conveyed to the kiosk.

In step 205, a product kiosk can display a product advertisement. The product advertisement can be an audio/video content. In one instance, the kiosk can be a rotating billboard able to present multiple product advertisements. For example, kiosk can be a tri-paneled rotating sign with three different advertisements of a product from the same marketing strategy. In step 210, a consumer proximate to the kiosk can be identified. In step 215, metrics can be collected from the consumer responsive to the interaction with the advertisement. It should be appreciated that metrics can be continually collected throughout the interaction with the kiosk. In one instance, steps 215-260 can repeat until a favorable impression is reached. That is, the disclosure can permit multiple normalizations of the advertisement to occur during the consumer interaction with the kiosk.

In step 220, metrics can be analyzed to determine the consumer impression. In step 225, if there are more consumers, the method can return to step 210, else continue to step 230. In step 230, a group impression can be optionally generated from two or more consumer impressions. In step 235, the impression (e.g., consumer, group) can be evaluated against one or more criteria. In step 240, if the impression of the advertisement is favorable, the method can continue to step 265, else proceed to step 245. In step 245, the impression is utilized to normalize the advertisement to improve consumer interaction. In step 250, normalized content can be generated from one or more normalization sources. Normalization sources can include, but is not limited to, consumer surveys, social group data (e.g., online social networks), and the like. In step 255, normalized content can be conveyed to the kiosk. The kiosk can modify the advertisement based on normalized content. In step 265, the method can end.

Drawings presented herein are for illustrative purposes only and should not be construed to limit the invention in any regard. It should be appreciated that method 200 can be performed in real-time or near real-time. One or more steps of the method 200 can be performed in serial or parallel.

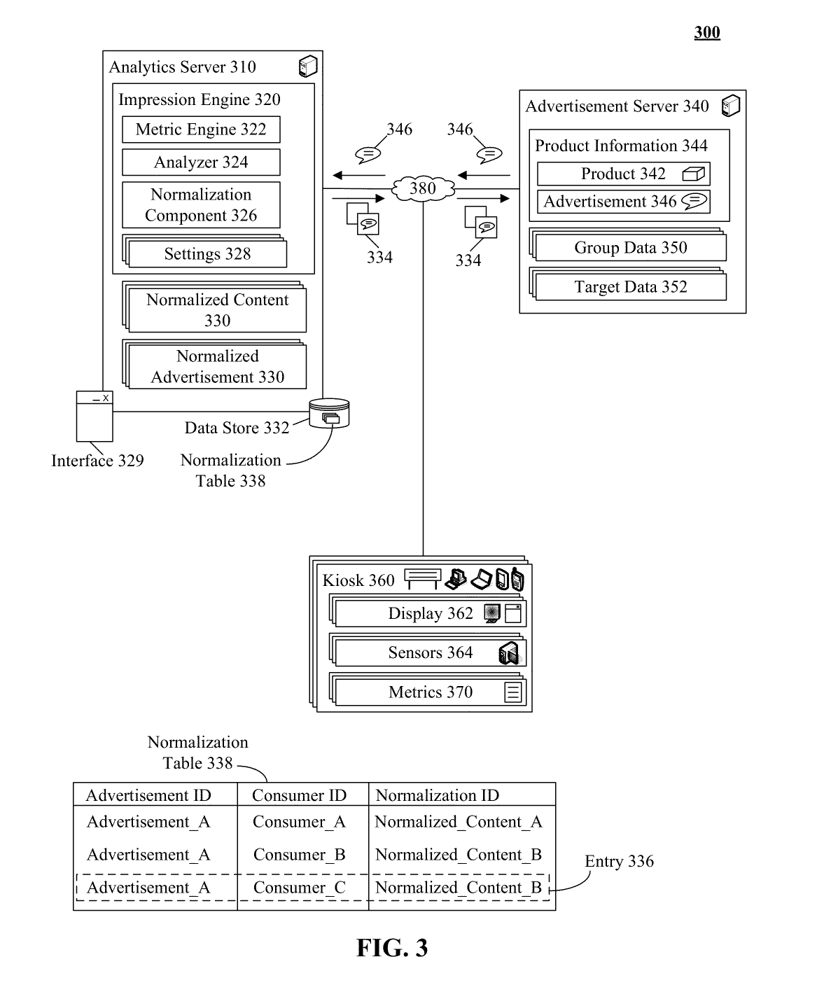

FIG. 3 is a schematic diagram illustrating a system 300 for utilizing real-time metrics to normalize an advertisement based on consumer reaction in accordance with an embodiment of the inventive arrangements disclosed herein. System 300 can be performed in the context of scenario 100, method 200, and/or embodiment 400, 420. In system 300, an analytics server 310 can provide dynamic advertisement normalization based on metrics 370 obtained from a proximate consumer (e.g., consumer 112). Impression engine 320 can utilize metrics 370, group data 350, and/or target data 352 to produce normalized advertisement 334 which can improve a consumer reaction to advertisement 346. Components within system 300 can be communicatively linked via network 380.

Analytics server 310 can be a hardware/software component able to execute impression engine 320. Analytics server 310 functionality can include, but is not limited to, data mining, decision management, predictive capabilities, and the like. Server 310 can include, but is not limited to, impression engine 320, normalized content 330, data store 332, interface 329, and the like. In one instance, server 310 can be an IBM WEBSPHERE APPLICATION SERVER.

Impression engine 320 can be a hardware/software element for permitting normalization of advertisement 346 responsive to a consumer reaction. Engine 320 functionality can include, but is not limited to, communication handling, server/resource tracking, administrative capabilities, and the like. Engine 320 can include, but is not limited to, metric engine 322, analyzer 324, normalization 326, settings 328, and the like. Engine 320 can be a networked computing element, a distributed computing element, and the like. In one instance, engine 320 can be a networked element which can be a “drop-in” solution which can rapidly and easily extend the capabilities of existing advertising infrastructures.

Metric engine 322 can be a hardware/software entity able to process metrics 370. Metric engine 322 functionality can include, but is not limited to, biometric processing, voice recognition, speech recognition, behavioral profiling, and the like. Metric engine 322 can include, but is not limited to, feature extraction, profile matching, and the like.

Analyzer 324 can be a hardware/software element configured to evaluate metrics 370 to determine consumer impression of advertisement 346. Analyzer 324 functionality can include, but is not limited to, ruleset evaluation, criteria based analysis, rating capabilities, and the like. In one instance, analyzer 324 can utilize psycho-graphic profiles to generate normalized content 330 which can be employed to create normalized advertisement 334.

Normalization component 326 can be a hardware/software component for generating normalized content 330 and/or normalized advertisement 334. Component 326 functionality can include, but is not limited to, video editing capabilities, audio editing functionality, text processing, content generation (e.g., Web page creation), and the like. In one instance, component 326 can convey normalized advertisement 334 to server 340. In the instance, server 340 can store advertisement 334 which can be conveyed to kiosk 360 appropriately.

Settings 328 can be one or more configuration options for establishing the behavior of server 310 and/or system 300. Settings 328 can include, but is not limited to, impression engine 320 options, metric engine 322 parameters, analyzer 324 settings, normalization component 326 options, and the like. It should be appreciated that setting 328 can enable sophisticated normalization of advertisement 346 and is not limited to the configurations described herein.

Normalization table 338 can be a data set utilized for managing normalized advertisement 334. Table 338 can include, but is not limited to, advertisement identifier, consumer identifier, normalization identifier, and the like. Table 338 can track one or more normalized advertisements 334 for an advertisement 346. For example, table 338 can include entry 336 which can associate a Normalized_Content_B with a specific Advertisement_A for a Consumer_C. That is, when Consumer_C is proximate to a kiosk, a normalized advertisement including Normalized_Content_B can be presented. Table 338 can be arbitrarily complex permitting tracking of normalized advertisements 334 with consumer reactions (e.g., computationally determined impression), multiple normalization content 330 for a normalized advertisement 334, and the like.

Advertisement server 340 can be a hardware/software element for conveying advertisement 346, normalization content 330, and/or normalized advertisement 334. Server 340 can include, but is not limited to product information 344, group data 350, target data 352, and the like. Server 340 functionality can include, but is not limited to, storing data associated with advertisement 346, collecting data 350, 352, and the like. In one instance, server 340 can convey advertisement 346 to server 310. Server 310 can adjust advertisement 346 appropriately and convey normalized advertisement 334 to server 340.

Interface 329 can be a user interactive component permitting interaction and/or presentation of settings 328. Interface 329 can be associated with a Web browser application, a desktop graphical interface, and the like. In one embodiment, interface 329 can be a screen of an administrative configuration tool. Interface 329 capabilities can include a graphical user interface (GUI), voice user interface (VUI), mixed-mode interface, and the like. In one instance, interface 329 can be communicatively linked to server 310. In the instance, interface 329 can be associated with a client computing device.

Data store 332 can be a hardware/software component able to persist normalized advertisement 334, normalized content 330, and the like. Data store 332 can be a Storage Area Network (SAN), Network Attached Storage (NAS), and the like. Data store 332 can conform to a relational database management system (RDBMS), object oriented database management system (OODBMS), and the like. Data store 332 can be communicatively linked to server 310 in one or more traditional and/or proprietary mechanisms. In one instance, data store 332 can be a component of Structured Query Language (SQL) complaint database.

In system 300, kiosk 360 can include display 362, sensors 364, metrics 370, and the like. In one instance, kiosk 360 can present advertisement 346 which can be served from advertisement server 340. In the instance, normalized advertisement 334 can be received from server 340 which can be presented within display 362. In one embodiment, display 362 can be a user interface such as a graphical user interface. In the embodiment, administrative functionality can be accessed allowing customized configuration of kiosk at the point of presence. Sensors 364 can include, but are not limited to, a barometer, a thermometer, and the like. In one instance, sensors 364 can determine environmental conditions which can be utilized to adjust advertisement 346 appropriately. For example, a consumer can be prone to respond more favorably to a new ice cream flavor being presented within advertisement 346 on a warm day versus a cooler day. It should be appreciated that sensors 364 can be external to kiosk 360. For example, a proximate store camera can be utilized to collect metrics as a consumer interacts with the kiosk 360 presenting advertisement 346.

Kiosk 360 can include, but is not limited to, computing devices which are associated with metric collection sensors. For example, kiosk 360 can be a laptop computer which can present an advertisement 346 and collect metrics via an integrated Webcam device.

Network 380 can be an electrical and/or computer network connecting one or more system 300 components. Network 380 can include, but is not limited to, twisted pair cabling, optical fiber, coaxial cable, and the like. Network 380 can include any combination of wired and/or wireless components. Network 380 topologies can include, but is not limited to, bus, star, mesh, and the like. Network 380 types can include, but is not limited to, Local Area Network (LAN), Wide Area Network (WAN), virtual network, and the like. Network 380 can include an Internet, an intranet, an extranet, and the like.

Drawings presented herein are for illustrative purposes only and should not be construed to limit the invention in any regard. In one embodiment, server 310 can be a component of a Service Oriented Architecture. In the embodiment, server 310 functionality can be encapsulated as a Web service.

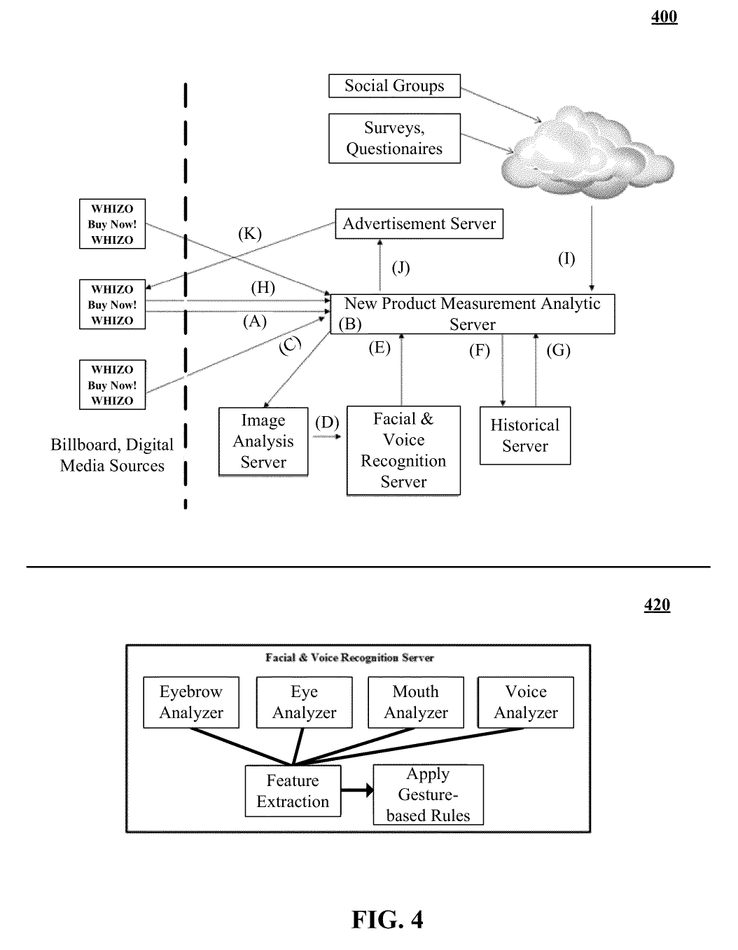

FIG. 4 is a schematic diagram illustrating an embodiment 400, 420 for utilizing real-time metrics to normalize an advertisement based on consumer reaction in accordance with an embodiment of the inventive arrangements disclosed herein. Embodiment 400, 420 can be present in the context of scenario 100, method 200, and/or system 300. In embodiment 400, a series of steps (e.g., A-K) can describe a technique for enabling dynamic advertisement normalization responsive to consumer reactions. Steps H-K can occur in parallel to steps A-G.

In embodiment 400, a video and audio content can be sent to New Product Measurement Analytic (NPMA) server. NPMA server can segment content and store video into Media Asset Management system. Content sent to Image Analysis server can be utilized to identify groups within an image (e.g., image of consumer face) and other relevant data. For example, image analysis can yield information such as how long the consumer viewed the advertisement and how often a repeat view occurred. Analyzed content from Image Analysis server can be sent to Facial and Voice recognition server. Facial and Voice recognition server can analyze video (e.g., video of the consumer) to determine if the response of the viewer group (e.g., consumer) is positive or negative. The consumer response (e.g., consumer biometrics) can be returned to NPMA server. Analytic server can examine historical data for given video to determine if consumer data is within the historical database.

Previously existing groups can be formulated from content available from multiple sources and/or historical data. Data can be returned to NPMA server and a final analysis can be performed to determine an individual's or a group's response to product or strategy. Sensor data from kiosks (e.g., billboard, digital media sources) can be sent to the NPMA server. Additional data from the Internet and other sources can be made available to NPMA server. NPMA server can analyze content and make recommendations to advertisement server on what type of advertisement content can be provided to normalize content based on external factors (e.g., social groups, surveys). Normalized content can be sent to the kiosks (e.g., display device).

Embodiment 420 illustrates an exemplary facial and voice recognition server which can be utilized to drive embodiment 400. Facial and voice recognition server can include, but is not limited to, eyebrow analyzer, eye analyzer, mouth analyzer, voice analyzer, feature extraction, and gesture-based rules.

The flowchart and block diagrams in the FIGS. 1-4 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be run substantially concurrently, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for determining consumer impression of a product associated with an advertisement comprising:
detecting a plurality of consumers proximate to a kiosk, wherein the kiosk presents a product advertisement associated with a product, wherein the product is at least one of a good and service;
collecting metrics associated with the at least one of the plurality of consumers responsive to interacting with the product advertisement, wherein the interaction is at least one of a visual and aural interaction;
analyzing the metrics to determine an impression associated with the at least one of the plurality of consumers interacting with the product advertisement, wherein the impression is at least one of a rational descriptor and an emotional descriptor, wherein the at least one of the rational descriptor and emotional descriptor is a computer readable value associated with a behavioral change of the at least one of the plurality of the consumers responsive to the interacting; and
generating a normalized content based on the impression associated with the consumer, wherein the normalized content adjusts the product advertisement to improve the impression.

2. The method of claim 1, wherein the metrics is obtained from at least one of a video and audio source.

3. The method of claim 1, wherein the metrics is obtained from a plurality of kiosks over a duration of time, wherein the metrics is associated with the plurality of consumers, wherein the plurality of kiosks is associated with a plurality of different geographic locations.

4. The method of claim 1, wherein the metrics is at least one of a verbal and non-verbal communication, wherein the non-verbal communication is at least one of a facial characteristic, a gesture, and a proxemics value, wherein the verbal communication is a speech utterance.

5. The method of claim 1, wherein the kiosk is at least one of an electronic kiosk, a billboard, and signage.

6. The method of claim 1, further comprising:
identifying a different product advertisement associated with the product;
predicting the impression of at least one of the plurality of consumers associated with the different advertisement.

7. The method of claim 1, further comprising:
identifying at least one of the plurality of consumers using facial recognition;
establishing the at least one of the plurality of consumers is associated with a group;
evaluating the impression associated with the at least one of the plurality of the consumers against group data associated with the group; and
determining the significance of the at least one of the plurality of consumers impression.

8. The method of claim 1, further comprising:
comparing the impression of one of the plurality of consumers to a different one of the plurality of consumers to create a group impression.

9. The method of claim 8, further comprising:
analyzing the group impression to determine an interest level; and
when the interest level is unfavorable, conveying a normalization content to the kiosk and normalizing the advertisement based on the normalization content.

10. A system for determining group impressions of a product advertisement comprising:
an impression engine configured to establish a group impression of a product advertisement, wherein the advertisement is associated with a kiosk, wherein the advertisement is associated with a product information, wherein the product information is associated with a product, wherein the product is at least one of a good and a service;
a data store configured to store at least one of the group impression and a normalization content.

11. The system of claim 10, further comprising:
a metrics engine able to collect metrics in real-time associated with a plurality of consumers proximate to the kiosk;
an analyzer configured to automatically analyze metrics to determine an impression associated with the plurality of consumers interacting with the product advertisement, wherein the interacting is at least one of a visual, aural, and tactile interacting, wherein the impression is comprised of at least one of a rational descriptor and an emotional descriptor, wherein the at least one of the rational descriptor and emotional descriptor is a computer readable value associated with a behavioral change of the at least one of the plurality of the consumers responsive to the interacting; and
a normalization component able to modify the product advertisement responsive to the evaluation of the impression.

12. An apparatus for determining group impressions of a product advertisement comprising:
a product kiosk having a plurality of sensors able to collect metrics in real-time associated with a plurality of consumers proximate to the kiosk, wherein the kiosk is configured to automatically determine an impression of the plurality of consumers, wherein the impression is associated with a product advertisement, wherein the product advertisement is comprised of product information.

13. The apparatus of claim 12, wherein the impression is a group impression, wherein the group impression is a plurality of impressions aggregated from each one of the plurality of consumers.

14. The apparatus of claim 13, further comprising:
evaluating the group impression against a target data to determine an appropriate interest level; and
programmatically changing the display of the kiosk responsive to the interest level, wherein the changing of the display is a content change associated with the product advertisement, wherein the content change is associated with the normalization content.

15. The apparatus of claim 12, wherein the kiosk is at least one of an electronic kiosk, a billboard, and signage.

16. The apparatus of claim 12, wherein the metrics is obtained from at least one of a video and audio source.

17. The apparatus of claim 12, wherein the metrics is an interaction metric, wherein the interaction metric is a tactile metric.

18. The apparatus of claim 12, wherein the metrics is at least one of a verbal and non-verbal communication, wherein the non-verbal communication is at least one of a facial characteristic, a gesture, and a proxemics value, wherein the verbal communication is a speech utterance.

19. The apparatus of claim 12, wherein the plurality of sensors is at least one of a camera, a microphone, a touch screen, a barometer, and a thermometer.

20. The apparatus of claim 12, wherein the metrics is obtained from a plurality of kiosks over a duration of time, wherein the metrics is associated with the plurality of consumers.
